(19) United States
(12) Patent Application Publication
(10) Pub. No.: US 2026/0328925 A1
(43) Pub. Date: Oct. 22, 2026

(54) ARRAY PROCESSING DEVICE

(71) Applicant: TRON FUTURE TECH INC., HSINCHU CITY (TW)

(72) Inventor: KUN-CHIEN HUNG, HSINCHU CITY (TW)

(21) Appl. No.: 19/646,587

(22) Filed: Apr. 14, 2026

Related U.S. Application Data
(60) Provisional application No. 63/792,367, filed on Apr. 22, 2025.

(51) Int. Cl. G01S 13/72; H04K 3/00

(52) U.S. Cl. CPC G01S 13/72; H04K 3/92

(57) ABSTRACT

The present application discloses an array processing device. The array processing device includes a plurality of front-end modules, a switching network coupled to the front-end modules, a software defined radio (SDR) module for controlling the front-end modules through the switching network, and a data processing module configured to establish a threat assessment principle. The SDR module performs a monitoring function by having a first part of the front-end modules receive RF signals from a monitoring region so as to detect if a remotely controlled object is present and if the remotely controlled object is threatening according to the threat assessment principle and the status information of the remotely controlled object. The SDR module performs a jamming function by having a second part of the front-end modules transmit jamming RF signals toward the remotely controlled object in response to the remotely controlled object is determined to be threatening.

### CROSS REFERENCE

This application claims the benefit of prior-filed U.S. provisional application No. 63/792,367, filed on Apr. 22, 2025, which is incorporated by reference in their entirety.

### TECHNICAL FIELD

The present disclosure relates to an array processing device, and more particularly, to an array processing device for countering remotely controlled objects.

### DISCUSSION OF THE BACKGROUND

As the electromagnetic spectrum becomes increasingly congested and complex, modern radio systems—such as military radars, electronic warfare equipment, and civilian 5G/6G communication base stations—face significant challenges in integrating multiple functions and responding rapidly to dynamic environments. However, most existing technologies still depend on hardware architectures designed for specific functions, which leads to several critical limitations.

For example, traditional systems often allocate separate and dedicated antenna arrays and radio frequency (RF) chains for radar, detection, and jamming tasks. This results in low hardware utilization and increased system complexity. Although software-defined radio (SDR) architectures offer greater flexibility, they frequently experience latency because decision-making and scheduling rely on general-purpose processors. In scenarios that require rapid frequency hopping, such as those involving modern unmanned aerial vehicles (UAVs) or tactical communications, these delays can cause missed opportunities for real-time jamming or tracking.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides an array processing device. The array processing device includes a plurality of front-end modules, a switching network, a software defined radio module, and a data processing module. The plurality of front-end modules receive and transmit RF signals. The switching network is coupled to the plurality of the front-end modules. The software defined radio module controls the plurality of front-end modules through the switching network to perform a monitoring function and a jamming function in a first mode. The data processing module establishes a threat assessment principle. The software defined radio module performs the monitoring function by having a first part of the plurality of front-end modules receive RF signals from a monitoring region so as to detect if a remotely controlled object is present in the monitoring region and derive status information of the remotely controlled object, and, in response to the remotely controlled object is detected, determines if the remotely controlled object is threatening according to the threat assessment principle and the status information. In response to the remotely controlled object is determined to be threatening, the software defined radio module further performs the jamming function by having a second part of the plurality of front-end modules transmit jamming RF signals toward the remotely controlled object.

Another aspect of the present disclosure provides a radio frequency system. The Radio frequency system includes a plurality of array processing devices aforementioned, and data processing modules of the plurality of array processing devices communicate with each other through a unified software interface for information exchange so as to achieve seamless cross-zone handover for the jamming function.

Another aspect of the present disclosure provides a method for countering a remotely controlled object with a plurality of front-end modules. The method includes establishing a threat assessment principle of the remotely controlled object, and performing a monitoring function. The step of performing the monitoring function includes having a first part of the plurality of front-end modules receive RF signals from a monitoring region so as to detect if the remotely controlled object is present in the monitoring region, deriving status information of the remotely controlled object according the RF signals received by the first part of the plurality of front-end modules, and determining if the remotely controlled object is threatening according to the threat assessment principle and the status information in response to the remotely controlled object is detected. In response to the remotely controlled object is determined to be threatening, the method further includes performing a jamming function. The step of performing the jamming function includes having a second part of the plurality of front-end modules transmit jamming RF signals toward the remotely controlled object.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows an array processing device according to one embodiment of the present disclosure.

FIG. 2 shows a utilizing scenario of the array processing device in FIG. 1 according to one embodiment of the present disclosure.

FIG. 3 shows a method for countering the remotely controlled object according to one embodiment of the present disclosure.

FIG. 4 shows a sequence of the functions performed by the software defined radio module according to one embodiment of the present disclosure.

FIG. 5 shows a utilizing scenario of the array processing device in FIG. 1 according to another embodiment of the present disclosure.

FIG. 6 shows a RF frequency system according to one embodiment of the present disclosure.

### DETAILED DESCRIPTION

The following description of the disclosure accompanies drawings, which are incorporated in and constitute a part of this specification, and which illustrate embodiments of the disclosure, but the disclosure is not limited to the embodiments. In addition, the following embodiments can be properly integrated to complete another embodiment.

References to "some embodiments," "an embodiment," "exemplary embodiment," "other embodiments," "another embodiment," etc. indicate that the embodiment(s) of the disclosure so described may include a particular feature, structure, or characteristic, but not every embodiment necessarily includes the particular feature, structure, or characteristic. Further, repeated use of the phrase "in the embodiment" does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

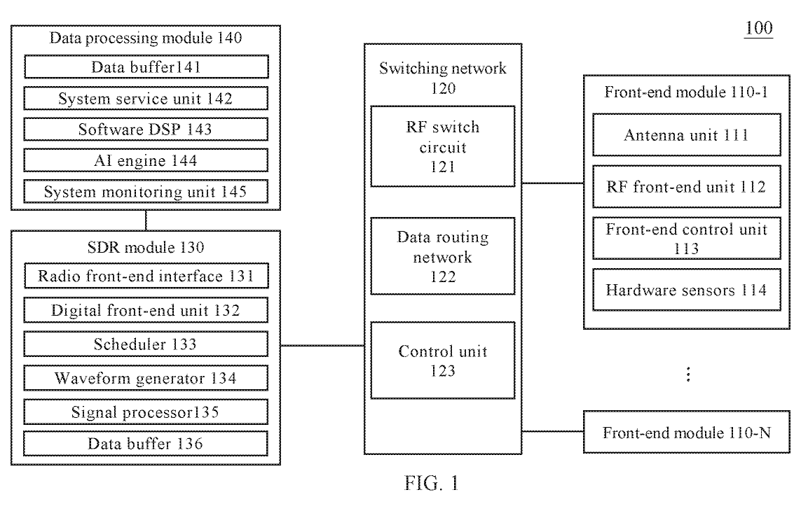

FIG. 1 shows an array processing device 100 according to one embodiment of the present disclosure. The array processing device 100 includes a plurality of front-end modules 110-1 to 110-N, a switching network 120, a software defined radio (SDR) module 130, and a data processing module 140. The front-end modules 110-1 to 110-N can be RF transceivers, and the switching network 120 can be coupled between the front-end modules 110-1 to 110-N and the SDR module 130. The switching network 120 allows to reconfigure the mappings between the physical antenna resources of the front-end modules 110-1 to 110-N and the logical channels of the SDR module 130, thereby enabling the formation of one or more virtual sub-arrays within the array processing device 100.

The array processing device 100 supports dual-loop control architecture. Specifically, the array processing device 100 can adopt the data processing module 140 as a control core of a slow loop for performing complicated computations and establishing reaction policies for various utilizing scenarios based on long-term data with AI models. Also, the array processing device 100 can adopt the SDR module 130 as a control core of a fast loop for fast controlling the front-end modules 110-1 to 110-N and the switching network 120 to perform corresponding functions according to the reaction policies established by the data processing device 140. Such control architecture makes the array processing device 100 suitable for complex applications that require rapid responses.

For example, in an application for countering remotely controlled objects, such as drones, the data processing module 140 may analyze, for example, with AI models, the signal spectrum of the remotely controlled object so as to recognize the product model of the remotely controlled object and predict the frequency hopping pattern of the remotely controlled object. Accordingly, the data processing module 140 can establish a policy lookup table for jamming and tracking the remotely controlled object. In such case, the SDR module 130 can detect the signal changes in the environment with the front-end modules 110-1 to 110-N and determine if any conditions specified in the policy lookup table is satisfied. If a certain condition is satisfied, the SDR module 130 can directly control the switching network 120 to reconfigure the signal path and have the front-end modules 110-1 to 110-N perform a corresponding function, such as transmitting jamming RF signals, tracking the remotely controlled object, or detecting the frequency band adopted by the remotely controlled object, according to the policy lookup table.

That is, since the front-end modules 110-1 to 110-N, the switch network 120, and the SDR module 130 are generic designed, the user may load different software to the data processing module 140 so as to configure the array processing device 100 to perform different functions in different modes or to perform multiple functions in one mode, thereby enabling a single hardware platform to flexibly perform multiple tasks, such as radar detection, wireless communication, electronic support measure (ESM), and electronic countermeasure (ECM), through software configuration and dynamic resource allocation.

For example, in one mode, the data processing module 140 may load the protocol stack and the QAM modulation waveforms so as to program the array processing device 100 to function as a base station or a relay station. In another mode, the data processing module 140 may load the waveform of linear frequency modulation (LMF)/frequency modulated continuous wave (FMCM) and the constant false alarm rate (CFAR) algorithm so as to program the array processing device 100 to function as a radar. Furthermore, in another mode, the data processing module 140 may load the frequency hopping prediction algorithm and the jamming waveform library so as to program the array processing device 100 to function as a drone countering system or an ECM system.

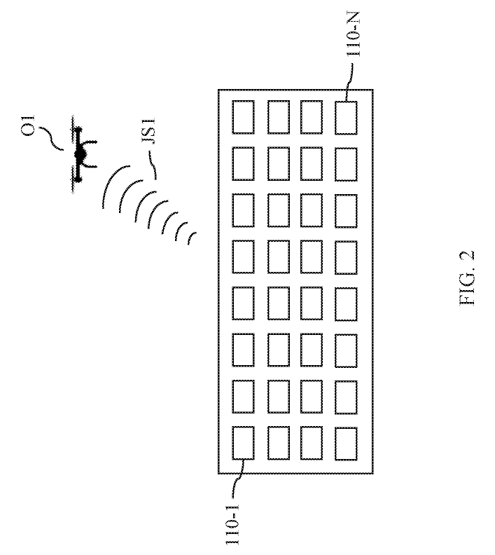

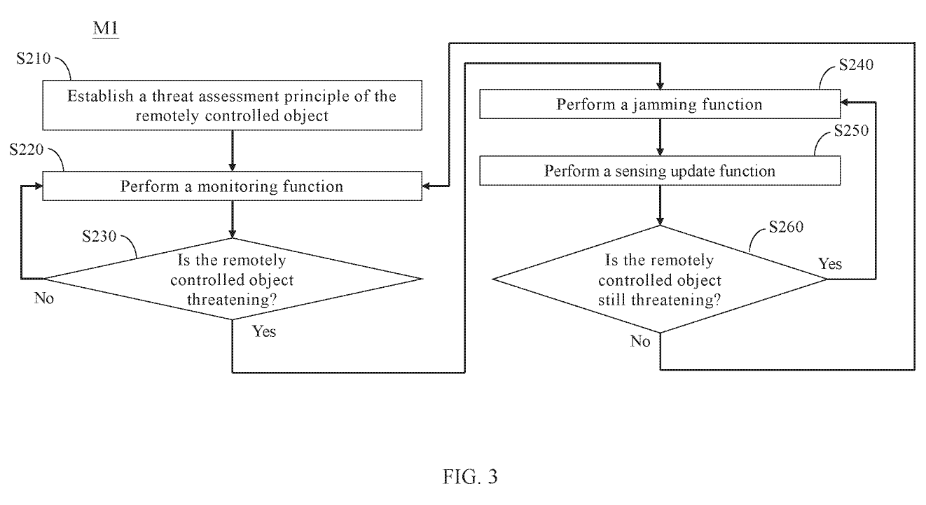

FIG. 2 shows a utilizing scenario of the array processing device 100 when in a mode for countering a remotely controlled object O1 according to one embodiment of the present disclosure. FIG. 3 shows a method M1 for countering the remotely controlled object O1 according to one embodiment of the present disclosure. The method M1 includes steps S210 to S260. In some embodiments, the method M1 can be performed with the array processing device 100.

In step S210, the data processing module 140 can establish a threat assessment principle of the remotely controlled object O1 so as to allow the SDR module 130 to determine if the remotely controlled object O1 is threatening. For example, the data processing module 140 may analyze the signals received from the front-end modules 110-1 to 110-N with AI models to derive the signal spectrum of the remotely controlled object, recognize the product model of the remotely controlled object and predict the frequency hopping pattern of the remotely controlled object O1. Accordingly, the data processing module 140 may establish the threat assessment principle so as to instruct the SDR module 130 to detect certain types of status information for determining if the remotely controlled object O1 is presented and threatening, thereby allowing the SDR module 130 to response to the threat immediately (e.g., adjusting the frequency band of the jamming RF signal JS1 to aligned with the prediction of the frequency hopping pattern). In the present embodiment, the threat assessment principle can be established as a policy look up table so as to facilitate the SDR module 130 to response to the threat instantly, however, the present disclosure is not limited thereto.

In step S220, the SDR module 130 can perform the monitoring function. In some embodiments, to perform the monitoring function, the SDR module 130 may have a first part of the front-end modules 110-1 to 110-N receive RF signals from a monitoring region so as to detect if the remotely controlled object O1 presents in the monitoring region. In some embodiments, the first part of the front-end modules 110-1 to 110-N may include all or only a part of the front-end modules 110-1 to 110-N. In response to the situation that the remotely controlled object O1 is detected, the SDR module 130 may further derive the status information of the remotely controlled object O1 according the RF signals received by the first part of the front-end modules 110-1 to 110-N, and determine if the remotely controlled object O1 is threatening according to the threat assessment principle (e.g., the policy lookup table) established by the data processing module 140 and the status information.

In some embodiments, the status information may include a moving direction of the remotely controlled object O1, a position of the remotely controlled object O1, intensity of a remote control signal of the remotely controlled object O1, an angle of arrival (AOA), and a frequency band adopted by the of the remotely controlled object O1 for communication. Also, the policy lookup table may specify multiple conditions, along with the corresponding actions to be taken when each condition is met. For example, if the SDR module 130 detects that the position of the remotely controlled object O1 has entered a predetermined restricted region (such as a no-fly zone), the signal intensity of the remotely controlled object O1 continuously increases, or the velocity of the remotely controlled object O1 exceeds a predetermined threshold, then the SDR module 130 may determine the remotely controlled object O1 to be threatening, and may further derive more information about the remotely controlled object O1, such as the AOA, the frequency band adopted by the of the remotely controlled object O1 for communication, so as to perform the jamming function in step S240 according to the derived information. However, if the remotely controlled object O1 is determined to be not threatening in step S230, then the step S220 may be repeated.

In step S240, the SDR module 130 may have a second part of the front-end modules 110-1 to 110-N transmit jamming RF signals JS1 toward the remotely controlled object O1. In some embodiments, the jamming RF signals JS1 are in the same frequency band as the frequency band adopted by the remotely controlled object O1 for communication, therefore, the jamming RF signal JS1 can cause interference in the communication between the remotely controlled object O1 and the remote controller, thereby rendering the remotely controlled object O1 uncontrollable and reducing its threat of attack.

In some embodiments, the first part of the front-end modules 110-1 to 110-N for receiving RF signals in step S220 may be same as the second part of the front-end modules 110-1 to 110-N for transmitting the jamming RF signals JS1 in step S240. However, the present disclosure is not limited thereto. In some embodiments, the first part of the front-end modules 110-1 to 110-N and the second part of the front-end modules 110-1 to 110-N may have members in common, or they may be completely distinct.

In addition, in some embodiments, the jamming RF signals JS1 can also be utilized as radar detection waves for tracking the remotely controlled object O1 so as to adjust the direction of the jamming RF signals JS1 as the remotely controlled object O1 moves, thereby continuously and effectively jamming the remotely controlled object O1. For example, in step S240, while having the second part of the front-end modules 110-1 to 110-N transmitting the jamming RF signals JS1, the SDR module 130 may further have a third part of the front-end modules 110-1 to 110-N receive reflection RF signals of the jamming RF signals JS1 so as to track the remotely controlled object O1. In other words, by processing the echo signal of the jamming RF signal JS1, the SDR module 130 can continuously track and locate the target’s distance and speed, and adjusting the direction of the next jamming beam accordingly.

In some embodiments, the jamming RF signals JS1 can have continuous waveform. In such case, the third part of the front-end modules 110-1 to 110-N for receiving the reflection RF signals of the jamming RF signals JS1 can be different from the part of the front-end modules 110-1 to 110-N for transmitting the jamming RF signals JS1. However, the present disclosure is not limited thereto. In some embodiments, the jamming RF signals JS1 may have pulsed radar waveforms, so as to facilitate the SDR module 130 to track the remotely controlled object O1. In such case, the third part of the front-end modules 110-1 to 110-N for receiving the reflection RF signals of the jamming RF signals JS1 may be distinct from the second part of the front-end modules 110-1 to 110-N for transmitting the jamming RF signals JS1, or the third part of the front-end modules 110-1 to 110-N may overlap, in whole or in part, the second part of the front-end modules 110-1 to 110-N.

As a result, the tracking function can be performed along with the jamming function, thereby improving the interference effect. However, the present disclosure is not limited thereto. In some embodiments, the jamming function may be performed without performing the tracking function. Furthermore, in some embodiments, the SDR module 130 may alternately perform the jamming function without performing the tracking function during a first period, and perform both the jamming function and the tracking function simultaneously during a second period. In some embodiments, the SDR module 130 can adjust the ratio between the first period and the second period according to their needs. For example, if the remotely controlled object O1 moves relatively slowly, then 30% of the time the SDR module 130 spent on performing the jamming function may be used to simultaneously perform the tracking function, so 70% of the time the SDR module 130 spent on performing the jamming function can be used for pure jamming, thereby interfering the remotely controlled object O1 more intensively. Conversely, if the target object moves relatively quickly, then 70% of the time spent on performing the jamming function may be also used to simultaneously perform the tracking function, so as to ensure the effectiveness of the jamming function.

After the jamming function has been performed for a predetermined time, the sensing update function can be performed in step S250. In step S250, the SDR module 130 may have a fourth part of the front-end modules 110-1 to 110-N receive RF signals from the monitoring region so as to derive updated status information of the remotely controlled object O1. For example, performing the sensing update function may include detecting if the remotely controlled object O1 is still in the communication, detecting if the remotely controlled object O1 is trying to reconnect to the controller, detecting if the remotely controlled object O1 has changed a frequency band for communication, and/or recalculating the AOA of the remotely controlled object O1.

Accordingly, in step S260, the SDR module 130 may determine if the remotely controlled object O1 is still threatening according to the threat assessment principle and the updated status information updated. In response to the situation that the remotely controlled object O1 is determined to be still threatening, the SDR module 130 may switch from performing the sensing update function to performing the jamming function. That is, the step S240 can be performed again to perform the jamming function. Furthermore, in such case, the jamming function can be performed with the jamming RF signals JS1 at the frequency band adopted by the remotely controlled object for communication, which is derived during the execution of the sensing update function in step S250.

Otherwise, if the remotely controlled object O1 is determined to be no longer threatening in step S260, then the SDR module 130 may switch from performing the sensing update function to performing the monitoring function. That is, the step S220 can be performed again so as to keep monitoring the targeted region. In some embodiments, the function switching can be implemented by a finite state machine of the SDR module 130. For example, when the finite state machine is in a certain state, the SDR module 130 may perform a corresponding function (e.g., the monitoring function in step S220, the jamming function in step S240, or the sensing update function in step S250), and the finite state machine may change its state according to the condition specified in the policy lookup table (e.g., the conditions set in step S230 or step S260).

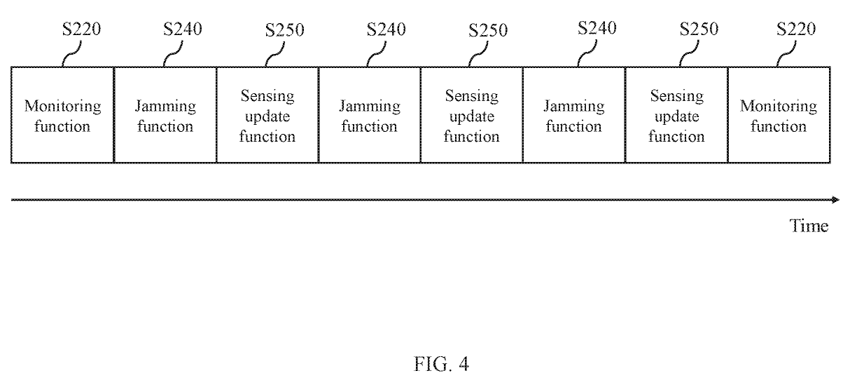

FIG. 4 shows a sequence of the functions performed by the SDR module 130 according to one embodiment of the present disclosure. As shown in FIG. 4, the SDR module 130 may perform the monitoring function of step S220 to detect the status of the monitor the remotely controlled object O1 first, and when the remotely controlled object O1 is determined to be threatening, the SDR module 130 may change its state and alternately perform the jamming function of step S240 and the sensing update function of step S250. Then, when the remotely controlled object O1 is determined to be not threatening according to the updated status information derived in the sensing update function, the SDR module 130 may change to its origin state and perform the monitoring function again to keep monitoring the remotely controlled object O1 and other objects that may potentially be threatening.

It should be noted that although the method M1 and the array processing device 100 are adopted to track and jam the remotely controlled object O1, the present disclosure is not limited thereto. In some embodiments, as the mapping between the SDR module 130 and the front-end modules 110-1 to 110-N can be reconfigured with the switching network 120, the front-end modules 110-1 to 110-N may be divided into different groups for tracking and jamming different remotely controlled objects. In other words, with the method M1 and the array processing device 100, multiple remotely controlled objects can be tracked and jammed simultaneously.

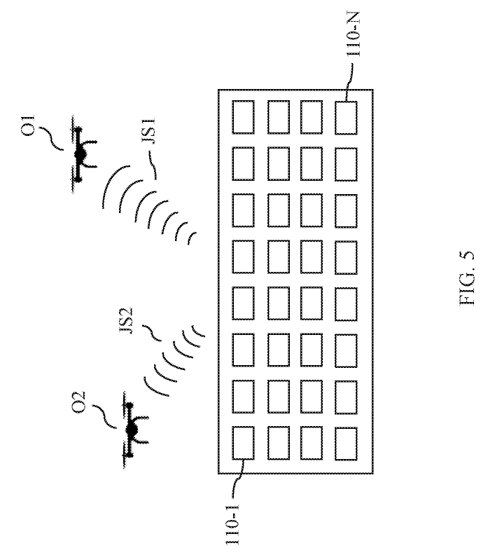

FIG. 5 shows a utilizing scenario of the array processing device 100 when in a mode for countering the remotely controlled objects O1 and O2 according to one embodiment of the present disclosure. As shown in FIG. 5, the array processing device 100 is able to transmit a jamming RF signal JS1 toward the remotely controlled object O1 and another jamming RF signal JS2 toward the remotely controlled object O2 with different parts of the front-end modules 110-1 to 110-N. Furthermore, in some embodiments, the jamming RF signal JS1 and the jamming RF signal JS2 can be in the different frequency band. For example, the jamming RF signal JS1 may have a central frequency of 2.4 GHz, and the jamming RF signal JS2 may have a central frequency of 5.2 GHz.

Furthermore, in some embodiments, the front-end modules 110-1 to 110-N may be adopted for performing different functions at the same time. For example, the front-end modules 110-1 to 110-N may include an 8x8 antenna array, and the 8x8 antenna array may be divided into two 4x8 sub arrays. In such case, by loading a corresponding software to the data processing module 140, it may allow the SDR module 130 to control a first sub array of the front-end modules 110-1 to 110-N through a first channel to perform a first function (e.g., the communication function), and control another part of the front-end modules through a second channel to perform a second function (e.g., the drone countering function), which is different from the first function. In some embodiments, these two sub-arrays can be completely decoupled in terms of frequency, direction, and timing, thereby enabling dual-mode operation on a single device or even multi-mode operation on a single device.

The following will further describe the functions of each module in the array processing device 100 and some exemplary components that may be included therein.

The front-end modules 110-1 to 110-N are employed to receive and transmit RF signals. In the present embodiment, each of the front-end modules 110-1 to 110-N can be designed as a line replaceable unit (LRU), and support hot swapping, thereby allowing users to replace the front-end modules on the platform as needed to support the required frequency bands.

As shown in FIG. 1, each of the front-end modules 110-1 to 110-N may include an antenna unit 111, a RF front-end unit 112, a front-end control unit 113, and hardware sensors 114. The antenna unit 111 is employed for the conversion between electromagnetic wave and electrical signals. It can be designed in a form of a dipole, patch, or horn, depending on the frequency band requirements. The antenna unit 111 can support multi-band operation. In addition, the antenna units 111 of the front-end modules 110-1 to 110-N can be arranged as an array, and the spacing between each two antenna units 111 can be set according to the requirements of a phased array for reducing grating lobes.

The RF front-end unit 112 is employed to process the analog signals. For example, the RF front-end unit 112 may include a power amplifier on the transmission path for amplifying the output signal to a power level that is high enough for radiation. Also, the RF front-end unit 112 may further include a low noise amplifier on the reception path for amplifying the input signal with low noise. In addition, the RF front-end unit 112 may include a high-speed switch or circulator to protect the receiving circuit from damage caused by high transmit power.

The front-end control unit 113 is employed for the physical operation of beam forming. For example, the front-end control unit 113 may include logic circuits for driving the digital step attenuator (DSA) and the digital phase shifter (DPS). In some embodiments, the front-end control unit 113 may store a calibration table so that when a backend instruction requests for a specific frequency and angle, the front-end control unit 113 can look up the calibration table for compensation, thereby ensuring the accuracy of the beam direction.

The hardware sensors 114 are employed for the prognostics and health management (PHM), and may include a temperature sensor, a voltage/current monitoring circuit, and/or a voltage standing wave ratio (VSWR) detector. The hardware sensors 114 may notify the front-end control unit 113 when an abnormal event (e.g., over temperature or antenna impedance mismatch) is detected, so that the front-end control unit 113 may reduce the power or shut down the power amplifier to prevent hardware damage.

The switching network 120 is coupled to the front-end modules 110-1 to 110-N and the SDR module 130, and employed as a routing hub between the front-end modules 110 and the SDR module 130. The switching network 120 allows to reconfigure the mappings between the physical antenna resources of the front-end modules 110-1 to 110-N and the logical channels of the SDR module 130, thereby enabling the formation and implementation of one or more virtual sub-arrays.

As shown in FIG. 1, the switching network 120 may include a RF switch circuit 121, a data routing network 122, and a control unit 123. The RF switch circuit 121 is utilized to control the physical routing of the RF signal paths. In some embodiments, the RF switch circuit 121 may be implemented by an array of high-speed solid-state switches (e.g., PIN diodes or GaN switches). The RF switch circuit 121 can dynamically connect any transmission/reception logic channel of the SDR module 130 to any front-end modules 110-1 to 110-N, thereby allowing the array processing device 100 to define the antenna aperture flexibly. For example, multiple front-end modules can be aggregated to one channel of the SDR module 130 so as to increase the gain, or the multiple front-end modules can be assigned to different channels for multi-beam operations.

The data routing network 122 is utilized for transmission of the digital control signals and measurement data. The data routing network 122 provides a low latency digital path (e.g., LVDS or optical fiber) for delivering the beam steering commands of the SDR module 130 to the front-end modules 110-1 to 110-N accurately and synchronously, and delivering the data received by the front-end modules 110-1 to 110-N to the SDR module 130.

The control unit 123 is utilize to coordinate the operation and timing of the switches in the switching network 120. Specifically, the control unit 123 can analyze the trigger signals issued by the scheduler of the SDR module 130 so as to ensure the switching of the RF paths and the radiation of the beams to be strictly aligned on a microsecond timescale, preventing signal interruption or impedance mismatch during the switching transitions.

The SDR module 130 is the processing core for real-time signal. In some embodiments, the SDR module 130 can be implemented by a field-programmable gate array (FPGA) cluster. As shown in FIG. 1, the SDR module 130 includes a radio front-end interface 131, a digital front-end unit 132, a scheduler 133, a waveform generator 134, a signal processor 135, and a data buffer 136.

The radio front-end interface 131 includes a digital up converter (DUC) and a digital down converter (DDC). For example, the radio front-end interface 131 may utilize a numerically controlled oscillator (NCO) and a mixer to shift the baseband in-phase and quadrature (IQ) signals to the target radio frequency, or to downconvert the RF signals to the baseband.

The digital front-end unit 132 is utilized for signal sampling rate conversion and channelization. For example, the digital front-end unit 132 may include a cascaded integrator-comb (CIC) filter and finite impulse response (FIR) filter to improve the receiver signal-to-noise ratio when performing decimation and to smooth the transmitted waveform when performing interpolation. Additionally, the digital front-end unit 132 may further support IQ imbalance correction and DC offset removal functions.

The scheduler 133 is utilized for microsecond-level tactical decision-making and timing control. Specifically, the scheduler 133 may include a finite state machine (FSM) embedded in FPGA logic, and may maintains a set of "trigger-action" rule tables (i.e., the policy lookup table) issued by the data processing module 140. In such case, when specific signal features are detected, the scheduler 133 can bypass the software layer and directly command the waveform generator 134 to switch waveforms and instruct the switching network 120 to switch paths. By utilizing the lookup table, the scheduler 133 is able to instantly switch states for performing corresponding functions according to changes in the received signal data. This feature is particularly suitable for applications where communication signals change rapidly, such as drone monitoring and jamming.

The waveform generator 134 is utilized to generate the desired waveforms required by the radar or communication. The waveform generator 134 supports the direct digital synthesis (DDC) and the memory playback modes. The waveform generator 134 is capable of generating linear frequency modulation (LFM/Chirp) radar pulses, OFDM communication symbols, Gaussian noise, and/or protocol-specific deception signals.

The signal processor 135 is employed to accelerate the mathematical computations. For example, the signal processor 135 may utilize the DSP slices of the FPGA to accelerate the execution of FFT (Fast Fourier Transform), correlation operations, pulse compression, and constant false alarm rate (CFAR) detection so as to extract target signals from the noise.

The data buffer 136 is utilized for data buffering across different clock domains. For example, the data buffer 136 may adopt high-speed FIFO or double data rate (DDR) memory to buffer high-speed streaming IQ data, thereby addressing the mismatch between the high-speed sampling at the front end and the processing speed at the back end.

The data processing module 140 is the core for high level service, and may be implemented by a CPU and/or a GPU. The data processing module 140 includes a data buffer 141, a system service unit 142, a software digital signal processor (DSP) 143, an AI engine 144, and a system monitoring unit 145.

The data buffer 141 receives the data received from the SDR module 130. In some embodiments, the data buffer 141 can be connected to the SDR module 130 via PCIe or high-speed Ethernet interface, thereby allowing the IQ data and/or the detection plots to be stored in system memory for software access.

The system service unit 142 provides low-level drivers and hardware abstraction layer (HAL). For example, the system service unit 142 may run the operating system (OS), manage the network protocol stack, and communicate with the switching network 120 and the front-end modules 110-1 to 110-N via slow control interface.

The software DSP 143 executes algorithms with high complexity but lower real-time requirements, such as the high-precision angle of arrival (AOA) direction-finding algorithms (such as MUSIC/ESPRIT), the multi-target trajectory tracking (e.g., Kalman Filter/Particle Filter) algorithm, as well as the algorithms required for communication, such as demodulation and decoding.

The AI engines 144 is utilized for cognition and decision-making. For example, the AI engines 144 may run deep learning models (such as CNN/RNN). In the application for countering remotely controlled objects, the AI engines 144 may utilize the deep learning models for signal fingerprint recognition (e.g., distinguishing the product model of the drones), frequency hopping pattern prediction, and optimal generation of jamming strategies (e.g., by reinforcement learning).

The system monitoring unit 145 is utilized for system-wide health management. For example, the system monitoring unit 145 may collect sensor data from the front-end modules 110-1 to 110-N, the switching network 120, and the SDR module 130 so as to monitor the temperature, power consumption and connection status, and provide fault diagnosis and automatic recovery functions.

It is to be understood that FIG. 1 is provided for illustrative purposes only and is not intended to limit the scope of the present invention. The front-end modules 110-1 to 110-N, the switching network 120, the SDR module 130, and the data processing module 140 shown in the embodiment may include additional components, or certain components may be omitted or combined, and all such modifications should be considered within the scope of the present invention.

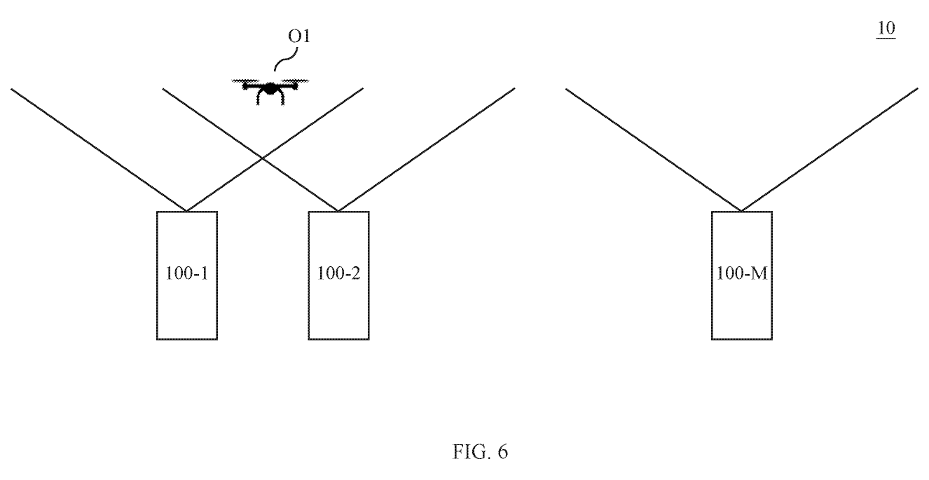

FIG. 6 shows a RF frequency system 10 according to one embodiment of the present disclosure. The RF frequency system 10 includes a plurality of array processing devices 100-1 to 100-M, where M is an integer greater than 1. In the present embodiment, each of the array processing devices 100-1 to 100-M may has the same structure as the array processing device 100 shown in FIG. 1, and the array processing devices 100-1 to 100-M can communicate with each other through a unified software interface for information exchange, thereby achieving cross device triangulation and seamless cross-zone handover for the jamming function. For example, when the array processing device 100-1 performs the jamming and tracking functions against the remotely controlled object O1, the status information of the remotely controlled object O1 derived by the array processing device 100-1 can be shared with other array processing devices 100-2 to 100-N. In such case, as the remotely controlled object O1 moves from a monitoring region of the array processing device 100-1 to a monitoring region of the array processing device 100-2, the array processing device 100-2 can take over immediately to perform the jamming and tracking functions against the remotely controlled object O1. In other words, the RF frequency system 10 allows to expand its monitoring region by adding more array processing devices, and share data among different array processing devices, thereby further improving the performance and flexibility of the RF frequency system 10.

In summary, the array processing devices, the RF frequency systems, and the methods for countering remotely controlled objects provided by the embodiments of the present disclosure allows to flexibly configure the front-end modules to perform the monitoring function, the jamming function and the tracking function. Furthermore, the dual loop control scheme of the array processing devices allows fast function switching within micro seconds, making it suitable for applications where communication signals change rapidly, such as drone countering. In addition, with software redefinition and antenna aperture reconfiguration, the array processing device also allows the same hardware to be configured for different applications, such as a radar system, a communication base station, and an electronic warfare system. The array processing devices even have the flexibility to perform multiple functions simultaneously, thereby improving the utilization of hardware resources.

Although the present disclosure and its advantages have been described in detail, it should be understood that various changes, substitutions and alterations can be made herein without departing from the spirit and scope of the disclosure as defined by the appended claims. For example, many of the operations discussed above can be implemented in different methodologies and replaced by other operations, or a combination thereof.

Moreover, the scope of the present application is not intended to be limited to the particular embodiments of the operation, machine, manufacture, composition of matter, means, methods and steps described in the specification. As one of ordinary skill in the art will readily appreciate from the present disclosure, operations, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such operations, machines, manufacture, compositions of matter, means, methods, and steps.

What is claimed is:

1. An array processing device, comprising:
a plurality of front-end modules configured to receive and transmit RF signals;
a switching network coupled to the plurality of the front-end modules;
a software defined radio module configured to control the plurality of front-end modules through the switching network to perform a monitoring function and a jamming function in a first mode; and
a data processing module configured to establish a threat assessment principle;
wherein, the software defined radio module is configured to:
perform the monitoring function by having a first part of the plurality of front-end modules receive RF signals from a monitoring region so as to detect if a remotely controlled object is present in the monitoring region and derive status information of the remotely controlled object, and, in response to the remotely controlled object is detected, determine if the remotely controlled object is threatening according to the threat assessment principle and the status information, and
perform the jamming function by having a second part of the plurality of front-end modules transmit jamming RF signals toward the remotely controlled object in response to the remotely controlled object is determined to be threatening.

2. The array processing device of claim 1, wherein the status information comprises a frequency band adopted by the remotely controlled object for communication, and the jamming function is performed with the jamming RF signals in the frequency band adopted by the remotely controlled object for communication.

3. The array processing device of claim 1, wherein when the software defined radio module performs the jamming function, the software defined radio module is further configured to have a third part of the plurality of front-end modules receive reflection RF signal of the jamming RF signal so as to track the remotely controlled object.

4. The array processing device of claim 3, wherein the jamming RF signals have pulsed radar waveforms, so as to facilitate the software defined radio module to track the remotely controlled object with reflected RF signals of the jamming RF signal.

5. The array processing device of claim 1, wherein the software defined radio module is further configured to perform a sensing update function, after the jamming function, by having a fourth part of the plurality of front-end modules receive RF signals from the monitoring region so as to derive updated status information of the remotely controlled object.

6. The array processing device of claim 5, wherein in response to the software defined radio module determines the remotely controlled object remains threatening according to the threat assessment principle and the updated status information updated during performing the sensing update function, the software defined radio module switches from performing the sensing update function to performing the jamming function.

7. The array processing device of claim 6, wherein the updated status information derived by the software defined radio module comprises a frequency band adopted by the remotely controlled object for communication, and after the sensing update function, the jamming function is performed with the jamming RF signals in the frequency band adopted by the remotely controlled object for communication.

8. The array processing device of claim 5, wherein in response to the software defined radio module determines the remotely controlled object is no longer threatening according to the threat assessment principle and the updated status information, the software defined radio module switches from performing the sensing update function to performing the monitoring function.

9. The array processing device of claim 1, wherein the data processing module is further configured to predict a frequency hopping pattern of the remotely controlled object, and the software defined radio module is further configured to adjust a frequency band of the jamming RF signal according to the frequency hopping pattern when performing the jamming function.

10. The array processing device of claim 1, wherein the data processing module is further configured to reconfigure the array processing device by having the software defined radio module control a part of the front-end modules to perform a first function and control another part of the front-end modules to perform a second function different from the first function.

11. The array processing device of claim 10, wherein the data processing module is further configured to program the array processing device as a base station in a second mode, and program the array processing device as a radar in a third mode.

12. A radio frequency system, comprising a plurality of array processing devices of claim 1, wherein data processing modules of the plurality of array processing devices are configured to communicate with each other through a unified software interface for information exchange so as to achieve seamless cross-zone handover for the jamming function.

13. A method for countering a remotely controlled object with a plurality of front-end modules, comprising:
establishing a threat assessment principle of the remotely controlled object;
performing a monitoring function, comprising:
having a first part of the plurality of front-end modules receive RF signals from a monitoring region so as to detect if the remotely controlled object is present in the monitoring region;
deriving status information of the remotely controlled object according the RF signals received by the first part of the plurality of front-end modules, and
determining if the remotely controlled object is threatening according to the threat assessment principle and the status information in response to the remotely controlled object is detected, and
in response to the remotely controlled object is determined to be threatening, performing a jamming function, comprising:
having a second part of the plurality of front-end modules transmit jamming RF signals toward the remotely controlled object.

14. The method of claim 13, wherein the status information comprises at least one of a moving direction of the remotely controlled object, a position of the remotely controlled object, intensity of a remote control signal of the remotely controlled object, an angle of arrival (AOA), and a frequency band adopted by the of the remotely controlled object for communication.

15. The method of claim 13, wherein the step of performing the jamming function further comprises having a third part of the plurality of front-end modules receive reflection RF signal of the jamming RF signal so as to track the remotely controlled object.

16. The method of claim 15, wherein the jamming RF signals have pulsed radar waveforms, so as to allow to track the remotely controlled object with reflected RF signals of the jamming RF signal.

17. The method of claim 13, further comprising, after the jamming function has been performed for a predetermined time, performing a sensing update function, comprising having a fourth part of the plurality of front-end modules receive RF signals from the monitoring region so as to derive updated status information of the remotely controlled object.

18. The method of claim 17, wherein further comprising, in response to the remotely controlled object is determined to be threatening according to the threat assessment principle and the updated status information updated during performing the sensing update function, switching from performing the sensing update function to performing the jamming function again.

19. The method of claim 18, wherein the updated status information comprises a frequency band adopted by the remotely controlled object for communication, and after the sensing update function, the jamming function is performed again with the jamming RF signals in the frequency band adopted by the remotely controlled object for communication.

20. The method of claim 17, wherein in response to the remotely controlled object is determined to be no longer threatening according to the threat assessment principle and the updated status information, switching from performing the sensing update function to performing the monitoring function.
